(19) United States
(12) Patent Application Publication
(10) Pub. No.: US 2019/0240655 A1
(43) Pub. Date: Aug. 8, 2019

(54) MICROCHIP

(71) Applicant: SEKISUI CHEMICAL CO., LTD., Osaka-city, Osaka (JP)

(72) Inventors: Tatsunori Takamatsu, Mishima-gun, Osaka (JP); Nobuhiko Inui, Mishima-gun, Osaka (JP); Shotaro Kobaru, Mishima-gun, Osaka (JP); Takamasa Kouno, Mishima-gun, Osaka (JP)

(21) Appl. No.: 16/329,866

(22) PCT Filed: Sep. 7, 2017
(86) PCT No.: PCT/JP2017/032244

§ 371 Date: Mar. 1, 2019

(30) Foreign Application Priority Data
Sep. 14, 2016 (JP) 2016-179333

(51) Int. Cl. B01L 3/00; F04B 43/06

(52) U.S. Cl. CPC B01L 3/50273; F04B 43/06; B01L 2300/0819; B01L 2400/0406; B01L 2300/0861; B01L 2300/0848

(57) ABSTRACT

The present invention provides a microchip that allows to highly accurately control a transported amount of a fluid. The microchip 1 includes: a container 3 encapsulating a liquid reagent X (fluid) filled in the container 3; and a substrate 2 including an accommodation section 4 in which the container 3 is placed. The accommodation section 4 includes a top surface and a bottom surface 2b. The accommodation section 4 is opened to the top surface of the substrate 2. At least a part of the inflow passage 5 that is connected to the accommodation section 4 and into which a medium for transporting the liquid reagent X flows is provided on the substrate 2. At least a part of the outflow passage 6 that is connected to the accommodation section 4 and through which the liquid reagent X flows out is provided on the substrate 2. The microchip 1 further includes a sheet member 7 that is provided on the top surface of the substrate 2 so as to close the opening of the accommodation section 4.

### TECHNICAL FIELD

The present invention relates to a microchip that encapsulates a liquid reagent and includes a channel for transporting a fluid.

### BACKGROUND ART

A microchip having a channel for transporting a fluid has been used in fields including biochemical analysis. In this case, some microchips encapsulate a reagent in advance. For example, Patent Literature 1 below proposes a microchip embedded with a blister pack encapsulating a liquid reagent. This microchip includes a space where the liquid reagent is mixed with a specimen or another reagent. In using the microchip, pressing the blister pack causes it to break, whereby the liquid reagent is released. The pressing force causes the released liquid reagent to be transported to a microchannel and flow into the space.

### CITATION LIST

### Patent Literature

Patent Literature 1: Japanese Patent No. 5466745

### SUMMARY OF INVENTION

### Technical Problem

In the microchip disclosed in Patent Literature 1, the pressing force on the blister pack serves as a driving force for transporting the liquid reagent. However, a position at which the blister pack is pressed, its pressure or a position at which the blister pack breaks can vary from one to another, leading to insufficient control over an amount of the liquid reagent to be transported to the microchannel.

The present invention aims to provide a microchip that allows to highly accurately control the transported amount of a fluid.

### Solution to Problem

The microchip according to the present invention includes: a container encapsulating a fluid; a substrate including an accommodation section in which the container is placed, the substrate including a top surface and a bottom surface, the accommodation section being opened to the top surface of the substrate; and a sheet member further provided on the top surface of the substrate so as to close the opening of the accommodation section, wherein the substrate includes: an inflow passage directly or indirectly connected to the accommodation section, the inflow passage allowing a medium for transporting the fluid to flow into the inflow passage; and an outflow passage directly or indirectly connected to the accommodation section, the outflow passage allowing the fluid to flow out through the outflow passage.

In a particular aspect of the microchip according to the present invention, the microchip further includes a driving section connected to the inflow passage, the driving section causing the medium to flow into the inflow passage to transport the fluid.

In another particular aspect of the microchip according to the present invention, the medium is a gas, and the driving section causes the gas to flow into the inflow passage.

In still another particular aspect of the microchip according to the present invention, the inflow passage and the outflow passage are directly connected to the accommodation section.

In still another particular aspect of the microchip according to the present invention, a part of at least one of the inflow passage and the outflow passage is provided on the top surface side of the substrate, and walls of the part on the top surface side are covered with the sheet member.

In still another particular aspect of the microchip according to the present invention, a part of the inflow passage and a part of the outflow passage are provided on the top surface side of the substrate, and walls of the inflow passage and the outflow passage on the top surface side are covered with the sheet member.

In still another particular aspect of the microchip according to the present invention, the inflow passage and the outflow passage are provided inside the substrate.

In still another particular aspect of the microchip according to the present invention, the outflow passage is provided inside the substrate, the accommodation section includes a retaining part inside the substrate, the retaining part being connected to the outflow passage, a cross-sectional area of the retaining part in a direction perpendicular to a fluid transporting direction, which is a direction in which the fluid is transported, being larger than a cross-sectional area of the outflow passage in the direction perpendicular to the fluid transporting direction.

In still another particular aspect of the microchip according to the present invention, the inflow passage includes plural inflow passages.

In still another particular aspect of the microchip according to the present invention, the microchip further includes a connecting channel connected to the accommodation section, wherein the inflow passage and the outflow passage are indirectly connected to the accommodation section via the connecting channel.

In still another particular aspect of the microchip according to the present invention, the substrate includes a base sheet and a substrate body on the base sheet, the substrate body including a through hole.

### Advantageous Effects of Invention

According to the present invention, a microchip that allows to highly accurately control a transported amount of a fluid can be provided.

### BRIEF DESCRIPTION OF DRAWINGS

FIG. 1 is a cross-sectional side view of a microchip according to a first embodiment of the present invention.

FIG. 2 is a plan view of the microchip according to the first embodiment of the present invention.

FIG. 3 is a schematic view of the microchip according to the first embodiment of the present invention.

FIG. 4 is a cross-sectional side view of a microchip according to a modified example of the first embodiment of the present invention.

FIG. 5 is a cross-sectional side view of a microchip according to a second embodiment of the present invention.

FIG. 6 is a cross-sectional side view of a microchip according to a third embodiment of the present invention.

FIG. 7 is a cross-sectional side view of a microchip according to a fourth embodiment of the present invention.

FIG. 8 is a cross-sectional side view of a microchip according to a fifth embodiment of the present invention.

FIG. 9 is a cross-sectional side view of a microchip according to a sixth embodiment of the present invention.

FIG. 10 is a plan view of a microchip according to a modified example of the sixth embodiment of the present invention.

FIG. 11 is a plan view of a microchip according to a seventh embodiment of the present invention.

FIG. 12 is a cross-sectional side view of a microchip according to an eighth embodiment of the present invention.

FIG. 13 is a cross-sectional side view of a microchip according to a ninth embodiment of the present invention.

FIG. 14 is a cross-sectional side view of a microchip according to a tenth embodiment of the present invention.

FIG. 15 is a cross-sectional side view of a microchip according to an eleventh embodiment of the present invention.

FIG. 16 is a cross-sectional side view of a microchip according to a twelfth embodiment of the present invention.

### DESCRIPTION OF EMBODIMENTS

Hereinafter, specific embodiments of the present invention will be described with reference to the drawings to provide an understanding of the present invention.

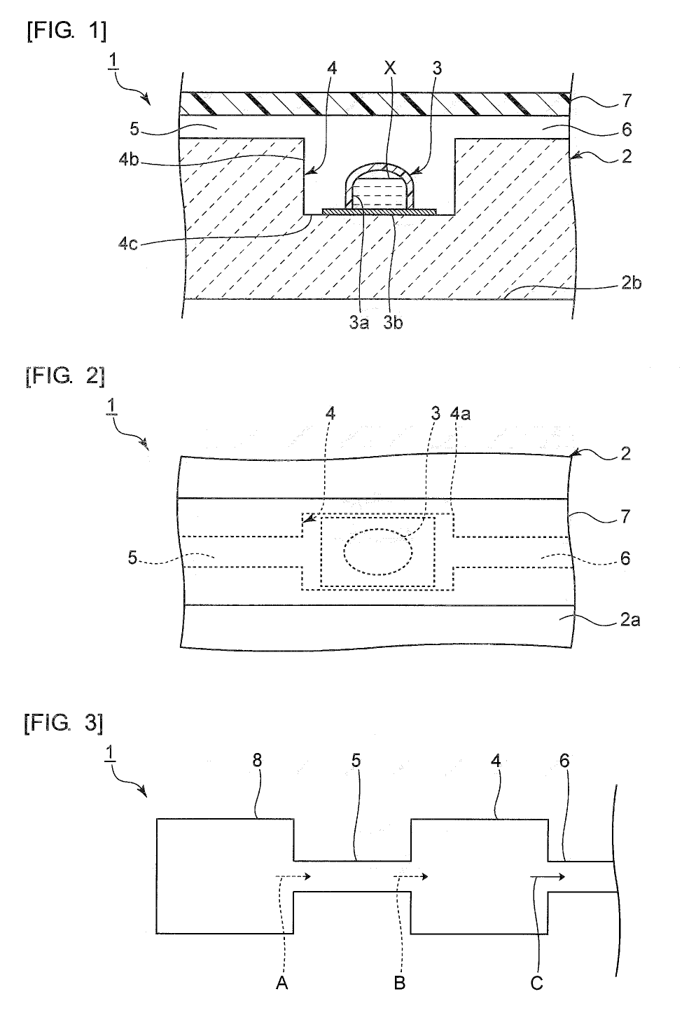

FIG. 1 is a cross-sectional side view of a microchip according to a first embodiment of the present invention. FIG. 2 is a plan view of the microchip according to the first embodiment. FIGS. 1 and 2 are enlarged views of a part of the microchip. The same applies to FIGS. 3 to 12 described later.

The microchip 1 shown in FIG. 1 may be used as a micro device for biochemical analysis or other purposes, though the microchip 1 is not limited to a particular use.

The microchip 1 includes a substrate 2. The substrate 2 includes a microchannel serving as a channel for transporting a fluid. The “microchannel” refers to a channel that is shaped and sized such that a liquid as a micro fluid flowing through the microchannel develops a so-called micro effect. Specifically, the “microchannel” refers to a channel that is shaped and sized such that a liquid flowing through the microchannel is affected by the surface tension and capillary phenomenon so strongly that the liquid behaves differently from one flowing through a channel with normal dimensions.

However, what shape and dimension of the channel can provide the micro effect depends on physical properties of the liquid to be led into the channel. For example, when the microchannel has a rectangular cross section, the height or the width of the cross section, whichever is shorter, is typically set to not more than 5 mm, preferably not more than 1 mm, more preferably not more than 500 μm, and even more preferably not more than 200 μm. This allows to make the microchip 1 even more smaller.

When the microchannel has a circular cross section, the diameter of the microchannel is typically set to not more than 5 mm, preferably not more than 1 mm, more preferably not more than 500 μm, and even more preferably not more than 200 μm. This allows to make the microchip 1 even more smaller. When the microchannel has an ellipse cross section, the diameter as referred to herein is the minor axis of the ellipse.

Also, for example when a pump or gravity is used to make a liquid flow in the microchannel having a rectangular cross section, the height or the width of the cross section, whichever is shorter, is typically preferably not less than 20 μm, more preferably not less than 50 μm, and even more preferably not less than 100 μm. This allows to further reduce a channel resistance.

Also, when the microchannel has a circular cross section, the diameter (the minor axis in the case of an ellipse cross section) is preferably not less than 20 μm, more preferably not less than 50 μm, and even more preferably not less than 100 μm.

Meanwhile, for example when the capillary phenomenon is effectively used to make a liquid flow in the microchannel having a substantially rectangular (including square) cross section, a shorter side of the cross section is preferably not less than 5 μm, more preferably not less than 10 μm, and even more preferably not less than 20 μm. Further, a shorter side of the cross section is preferably not more than 200 μm, and more preferably not more than 100 μm.

The substrate 2 includes a top surface 2a and a bottom surface 2b, and has a rectangular plate shape, though the substrate 2 is not limited to a particular shape. The substrate 2 may be either composed of plural layers or a single layer.

The substrate 2 may be made of, for example, resin, glass or ceramics. Examples of the resin for the substrate 2 include an organic siloxane compound, a polymethacrylate resin, a polyolefin resin such as polypropylene, and a cyclic polyolefin resin such as cycloolefin polymer. Specific examples of the organic siloxane compound include polydimethylsiloxane (PDMS) and polymethyl hydrogen siloxane.

As shown in FIG. 2, the substrate 2 includes an accommodation section 4 that includes an opening 4a being opened to the top surface 2a. The accommodation section 4 is a cuboid recess formed on the top surface 2a. As shown in FIG. 1, the accommodation section 4 includes a side part 4b and a bottom part 4c, Note that the shape of the accommodation section 4 is not limited to that described above.

A container 3 is placed on the bottom part 4c of the accommodation section 4. A liquid reagent X as a fluid is filled in, and encapsulated by, the container 3. The container 3 is a blister pack including a wall part 3a having an opening and a lid part 3b closing the opening of the wall part 3a. The container 3 is not limited to this and may be a capsule or a bag-like container, or other container that are able to encapsulate a liquid.

FIG. 3 is a schematic view of the microchip according to the first embodiment.

In the present embodiment, a gas is used as a medium to transport the fluid. The microchip 1 includes a driving section 8 that makes the gas flow into the microchannel. In the microchip 1, the driving section 8 is provided on the substrate. The driving section 8 contains a gas generating agent that generates a gas. The gas generating agent is not limited to a particular kind. The gas generating agent may be one that generates a gas by being heated or one that generates a gas by being irradiated with light.

The microchip 1 includes an inflow passage 5 connected to the driving section 8. As shown by the dashed arrow A in FIG. 3, the gas flows into the inflow passage 5. The inflow passage 5 is connected to the accommodation section 4. As shown by the dashed arrow B, the gas flows from the inflow passage 5 into the accommodation section 4. The microchip 1 further includes an outflow passage 6 connected to the accommodation section 4. When the microchip 1 is used, the liquid reagent is made flow out of the container to the accommodation section 4, though details are described later. The liquid reagent is transported by the gas to flow out into the outflow passage 6, as shown by the solid arrow C.

Although the inflow passage 5 and the outflow passage 6 are directly connected to the accommodation section 4 in the present embodiment, they may be indirectly connected to the accommodation section 4 as in the seventh and eighth embodiments described later.

Returning to FIG. 2, a sheet member 7 is provided on the top surface 2a of the substrate 2 so as to close the opening 4a of the accommodation section 4. This hinders a foreign material from entering the microchannel. In the present embodiment, a part of the inflow passage 5 and a part of the outflow passage 6 are provided on the top surface 2a side of the substrate 2. Each of walls of the inflow passage 5 and the outflow passage 6 on the top surface 2a include a part of the sheet member 7.

The sheet member 7 is not limited to a particular material, and is made of, for example, silicone rubber, natural rubber, chloroprene rubber, ethylene rubber, olefin elastomer such as ethylene propylene diene rubber (EPDM), styrene elastomer, urethane foam or acrylic foam.

When the sheet member 7 is made of an elastically deformable material as above mentioned, the sheet member 7 may be repeatedly deformed by being repeatedly pressed. Accordingly, when liquid reagents X, and Y filed in two or more containers 3 are used as in the eleventh embodiment described later, repeatedly pressing the containers 3 allows to more reliably mix the liquid reagents X and Y, which are respectively filled in different containers 3.

Instead, the sheet member 7 may be made of a plastically deformable material. When the sheet member 7 is made of a plastically deformable material, deformation of the sheet member 7 may be more reliably maintained, which in turn allows to more reliably transport the liquid reagent X with a gas.

Examples of the plastically deformable material include a resin film. Examples of the plastically deformable resin film include a polyurethane film, a polyolefin film and a polyvinyl chloride film.

A feature of the present embodiment lies in that the substrate 2 includes the inflow passage 5 and the outflow passage 6. This allows to highly accurately control a transported amount of the liquid reagent as a fluid. This will be explained below.

In using the microchip 1 shown in FIG. 1, the sheet member 7 is pressed to be deformed, whereby the container 3 is pressed via the sheet member 7. This causes the liquid reagent X to be released from the container 3 into the accommodation section 4. Then, a gas is made flow out of the driving section into the inflow passage 5 while deformation of the sheet member 7 is maintained. As this time, a channel is formed by the accommodation section 4 and the deformed sheet member 7, and the liquid reagent X is present within the channel. The gas passes through the inflow passage 5 to reach the accommodation section 4, transporting the liquid reagent X present within the channel. The liquid reagent X is transported by the gas to flow out through the outflow passage 6.

In this way, the liquid reagent X is retained within the accommodation section 4 when released from the container 3 and hardly flows out through the outflow passage 6. This prevents variation in the transported amount of the liquid reagent X, which is due to variation in the position at which the container 3 is pressed or variation in the pressure by which the container 3 is pressed. The amount of the liquid reagent X flowing out through the outflow passage 6 can be adjusted according to the supplied amount of gas. This allows to highly accurately control the transported amount of the liquid reagent X.

In the present embodiment, the microchip 1 includes the driving section 8 shown in FIG. 3. However, the microchip 1 may not necessarily include the driving section 8. For example, when the microchip 1 is used, the microchip 1 may be connected to a pump or a syringe for supplying a gas. The medium for transporting a fluid is not limited to a gas and may be a liquid. Nevertheless, the medium is preferably a gas because using a gas as the medium prevents the fluid and the medium from being mixed with each other.

The sheet member 7 is preferably made of a plastic material. Using a plastic material allows to suitably maintain the deformation of the sheet member 7 when the microchip 1 is used.

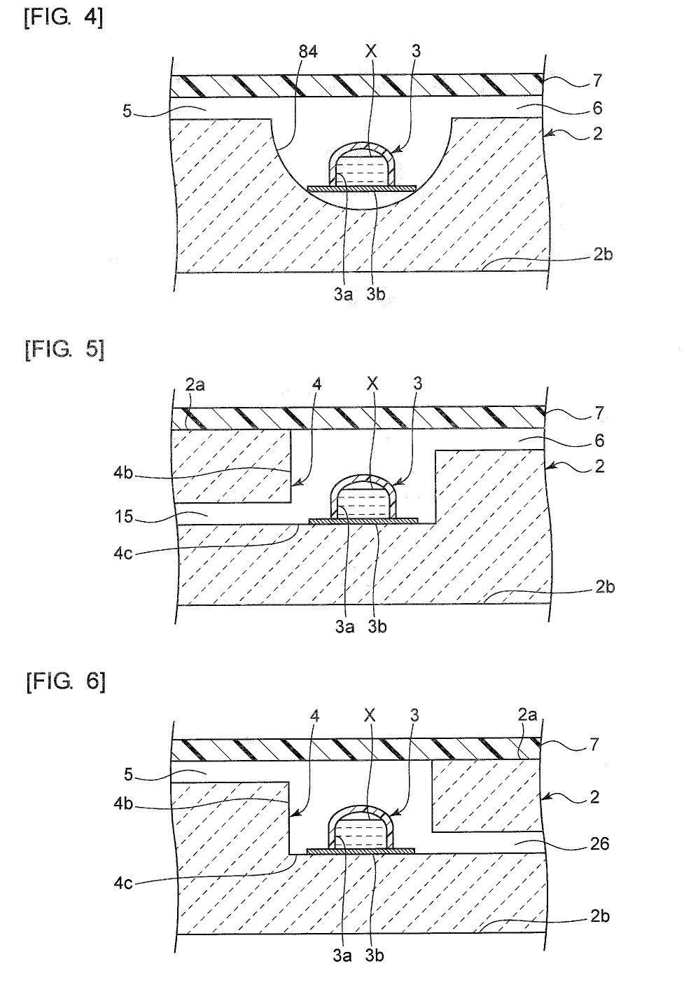

As described above, the accommodation section 4 of the microchip 1 is a cuboid recess. However, the shape of the accommodation section 4 is not limited to this. For example, as in a modified example of the first embodiment shown in FIG. 4, an accommodation section 84 may have a mortar shape.

FIG. 5 is a cross-sectional side view of a microchip according to a second embodiment.

The microchip according to the second embodiment is different from the first embodiment in that an inflow passage 15 is provided inside the substrate 2. In the other respects, the microchip of the second embodiment has the same structure as that of the first embodiment.

The inflow passage 15 is connected to the side part 4b of the accommodation section 4. An opening of the inflow passage 15 opening to the side part 4b reaches the bottom part 4c of the accommodation section 4. However, the position at which the inflow passage 15 opens to the side part 4b is not limited to this. Alternatively, the inflow passage 15 may be connected to the bottom part 4c of the accommodation section 4.

Similarly to the first embodiment, the present embodiment allows to highly accurately control the transported amount of the liquid reagent X.

FIG. 6 is a cross-sectional side view of a microchip according to a third embodiment.

The microchip according to the third embodiment is different from the first embodiment in that an outflow passage 26 is provided inside the substrate 2. In the other respects, the microchip of the third embodiment has the same structure as that of the first embodiment.

The outflow passage 26 is connected to the side part 4b of the accommodation section 4. An opening of the outflow passage 26 opening to the side part 4b reaches the bottom part 4c of the accommodation section 4. This allows the liquid reagent X to be suitably situated at or near the opening of the outflow passage 26 when the liquid reagent X is released from the container 3. Accordingly, this can reduce the amount of medium required to make the liquid reagent X flow out. Further, similarly to the first embodiment, the present embodiment allows to highly accurately control the transported amount of the liquid reagent X.

The position at which the outflow passage 26 opens to the side part 4b is not limited to that described above. Alternatively, the outflow passage 26 may be connected to the bottom part 4c of the accommodation section 4.

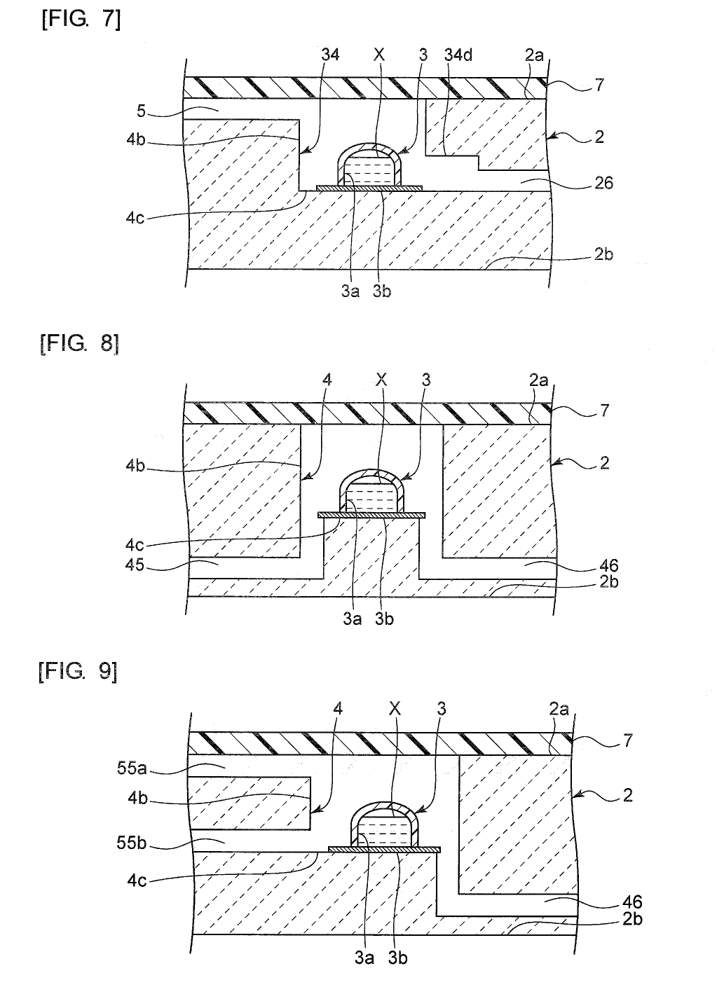

FIG. 7 is a cross-sectional side view of a microchip according to a fourth embodiment.

The microchip according to the fourth embodiment is different from the third embodiment in that an accommodation section 34 includes a retaining part 34d provided inside the substrate 2 and the retaining part 34d is connected to the outflow passage 26. In the other respects, the microchip of the fourth embodiment has the same structure as that of the third embodiment.

Here, a direction in which the liquid reagent X is transported by a medium such as a gas is referred to as a fluid transporting direction. A cross-sectional area of the retaining part 34d in a direction perpendicular to the fluid transporting direction is larger than a cross-sectional area of the outflow passage 26 in a direction perpendicular to the fluid transporting direction. This allows the liquid reagent X to be suitably retained at the retaining part 34d when the liquid reagent X is released from the container 3. This allows to more reliably retain the liquid reagent X in the accommodation section 34 until a medium for transporting the liquid reagent X is supplied into the accommodation section 34. Accordingly, this allows to more reliably and highly accurately control the transported amount of the liquid reagent X. Further, similarly to the third embodiment, the present embodiment allows to reduce the amount of medium required to make the liquid reagent X flow out.

In the first to fourth embodiments, a part of at least one of the inflow passage and the outflow passage is provided on the top surface 2a of the substrate 2. However, both of the inflow passage and the outflow passage may be provided inside the substrate 2. An example of this will be explained below.

FIG. 8 is a cross-sectional side view of a microchip according to a fifth embodiment.

In the microchip of the fifth embodiment, an inflow passage 45 and an outflow passage 46 are provided inside the substrate 2. The inflow passage 45 and the outflow passage 46 are connected to the bottom part 4c of the accommodation section 4. Thus, walls of the inflow passage 45 and the outflow passage 46 do not include a part of the sheet member 7. As a result, the inflow passage 45 and the outflow passage 46 are hardly deformed and closed by pressing of the sheet member 7 in using the microchip. This allows to more reliably transport the liquid reagent X. Further, similarly to the first embodiment, the present embodiment allows to highly accurately control the transported amount of the liquid reagent X.

FIG. 9 is a cross-sectional side view of a microchip according to a sixth embodiment.

The microchip according to the sixth embodiment includes plural inflow passages 55a, 55b. The inflow passage 55a is provided on the top surface 2a of the substrate 2. The inflow passage 55b is provided inside the substrate 2. The inflow passages 55a, 55b are connected to the side part 4b of the accommodation section 4. On the other hand, the outflow passage 46 is provided inside the substrate 2 and connected to the bottom part 4c of the accommodation section 4.

The microchip of the present embodiment includes the plural inflow passages 55a, 55b, and this allows to more reliably make the liquid reagent X flow out through the outflow passage 46 by using a medium such as a gas. This can reduce a residual amount of the liquid reagent X in the accommodation section 4, which in turn reduces an amount of the liquid reagent X to be filled in the container 3. Further, similarly to the first embodiment, the present embodiment allows to highly accurately control the transported amount of the liquid reagent X.

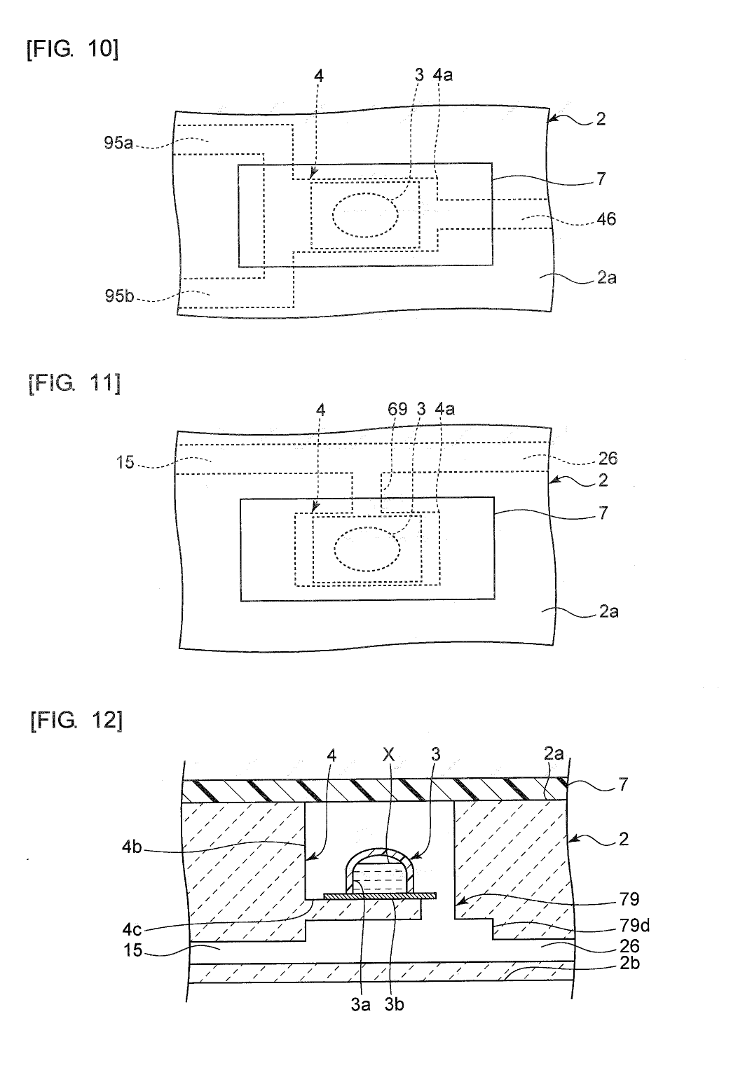

The plural inflow passages 55a, 55b are not limited to a particular arrangement. For example, as in a modified example of the sixth embodiment shown in FIG. 10, the plural inflow passages 95a, 95b may not overlap each other in a plan view. The inflow passages 95a, 95b may be entirely inside the substrate 2. The microchip may include three or more inflow passages. Arranging plural inflow passages according to factors such as a shape of the accommodation section allows to even more reliably make the liquid reagent X flow out through the outflow passage 46. This can further reduce the amount of the liquid reagent X to be filled in the container 3.

FIG. 11 is a plan view of a microchip according to a seventh embodiment.

The microchip according to the seventh embodiment of the present invention includes a connecting channel 69 connected to the accommodation section 4. The inflow passage 15 and the outflow passage 26 are indirectly connected to the accommodation section 4 via the connecting channel 69. The connecting channel 69, the inflow passage 15 and the outflow passage 26 are provided inside the substrate 2.

The position at which the connecting channel 69 is connected to the accommodation section 4 is not limited to a particular position; the connecting channel 69 may be connected to the side part or the bottom part of the accommodation section 4.

In the present embodiment too, the microchip includes the inflow passage 15 and the outflow passage 26, and this allows to highly accurately control the transported amount of the liquid reagent by controlling the supplied amount of medium to transport the liquid reagent.

FIG. 12 is a cross-sectional side view of a microchip according to an eighth embodiment.

In the microchip according to the eighth embodiment, a connecting channel 79 is connected to the bottom part 4c of the accommodation section 4, and the connecting channel 79 includes a retaining part 79d. The inflow passage 15 and the outflow passage 26 are connected to the retaining part 79d. A cross-sectional area of the retaining part 79d in a direction perpendicular to the fluid transporting direction is larger than a cross-sectional area of the outflow passage 26 in the direction perpendicular to the fluid transporting direction. This allows the liquid reagent X to be suitably retained at the retaining part 79d when the liquid reagent X is released from the container 3. This allows to more reliably and highly accurately control the transported amount of the liquid reagent X, similarly to the fourth embodiment. Also, this can reduce the amount of medium required to make the liquid reagent X flow out.

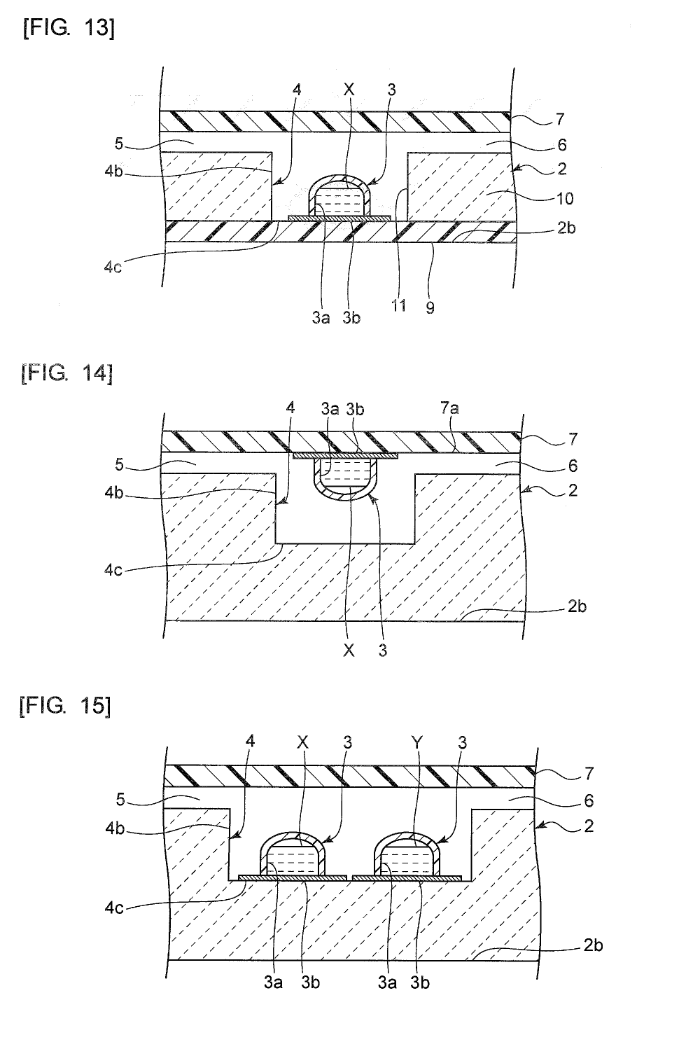

FIG. 13 is a cross-sectional side view of a microchip according to a ninth embodiment.

In the microchip according to the ninth embodiment, the substrate 2 includes a base sheet 9 and a substrate body 10. The substrate body 10 is provided on the base sheet 9. The substrate body 10 includes a through hole 11.

As the base sheet 9, for example, a pressure-sensitive adhesive tape or an adhesive tape may be used. Examples of the pressure-sensitive adhesive tape include one formed by placing a pressure-sensitive adhesive on a substrate film. Examples of the adhesive tape include one formed by placing an adhesive on a substrate film. Examples of the substrate film include polyethylene terephthalate film (PET film). Examples of the adhesive include a cyanoacrylate-based adhesive, an elastomer-based adhesive and a hot-melt adhesive using a thermoplastic resin. Examples of the pressure-sensitive adhesive include a silicone-based pressure-sensitive adhesive and an acrylic pressure-sensitive adhesive.

The substrate body 10 may be made of, for example, resin, glass or ceramics. Examples of the resin for the substrate body 10 include an organic siloxane compound, a polymethacrylate resin, a polyolefin resin such as polypropylene, and a cyclic polyolefin resin such as cycloolefin polymer. Specific examples of the organic siloxane compound include polydimethylsiloxane (PDMS) and polymethyl hydrogen siloxane.

Like the microchip according to the ninth embodiment, the substrate 2 may be composed of the base sheet 9 and the substrate body 10. In this case, the container 3 encapsulating the liquid reagent X is placed after the sheet member 7 and the substrate body 10 are joined, and finally the base sheet 9 is attached. In this case, the container 3 filled with the liquid reagent X is placed after the joining of the sheet member 7 and the substrate body 10. This ensures that even when the sheet member 7 and the substrate body 10 are joined by a method that applies heat or pressure such as a heat-fusion method, the container 3 is not broken by such heat or pressure during the joining. In this case, after the placement of the container 3, the base sheet 9 made of a pressure-sensitive adhesive tape, an adhesive tape or the like may be joined by a method that does not apply heat or high pressure.

Similarly to the microchip according to the first and other embodiments, the substrate 2, which is formed by integrating the substrate body 10 and the base sheet 9, may also be used in the present embodiment.

In the present embodiment too, the microchip includes the inflow passage 5 and the outflow passage 6, and this allows to highly accurately control the transported amount of the liquid reagent by controlling the supplied amount of medium to transport the liquid reagent.

FIG. 14 is a cross-sectional side view of a microchip according to a tenth embodiment.

In the microchip according to the tenth embodiment, the container 3 encapsulating the liquid reagent X is not in contact with the substrate 2. The container 3 filled with the liquid reagent X is provided on a main surface 7a of the sheet member 7 facing the substrate 2. In the other respects, the tenth embodiment is the same as the first embodiment.

As in the present embodiment, the container 3 encapsulating the liquid reagent X may be provided on the main surface 7a of the sheet member 7 facing the substrate 2. Further, in the present embodiment too, the microchip includes the inflow passage 5 and the outflow passage 6, and this allows to highly accurately control the transported amount of the liquid reagent X by controlling the supplied amount of medium to transport the liquid reagent X.

FIG. 15 is a cross-sectional side view of a microchip according to an eleventh embodiment.

In the microchip according to the eleventh embodiment, two containers 3 are provided on the bottom part 4c of the accommodation section 4. The liquid reagent X and a liquid reagent Y are respectively filled in, and encapsulated by, the two containers 3. In the other respects, the eleventh embodiment is the same as the first embodiment.

As in the present embodiment, plural containers 3 may be provided. Further, in the present embodiment too, the microchip includes the inflow passage 5 and the outflow passage 6, and this allows to highly accurately control the transported amount of the liquid reagents X and Y by controlling the supplied amount of medium to transport the liquid reagents X and Y.

As described above, in this case, the sheet member 7 is preferably made of an elastically deformable material. When the sheet member 7 is made of an elastically deformable material, the liquid reagents X and Y respectively filled in the different containers 3 may be mixed with each other with an even higher accuracy by repeatedly pressing and thereby deforming the sheet member 7.

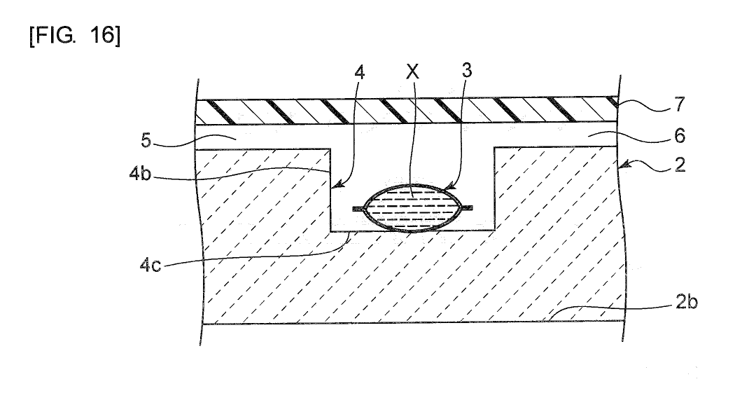

FIG. 16 is a cross-sectional side view of a microchip according to a twelfth embodiment.

In the microchip according to the twelfth embodiment, the container 3 is a bag-like film pack. In the twelfth embodiment too, pressing the bag-like film pack as the container 3 causes the film pack to break, whereby the liquid reagent X is released. In the other respects, the twelfth embodiment is the same as the first embodiment.

In the present embodiment too, the microchip includes the inflow passage 5 and the outflow passage 6, and this allows to highly accurately control the transported amount of the liquid reagent X by controlling the supplied amount of medium to transport the liquid reagent X.

### REFERENCE SIGNS LIST

1 Microchip
2 Substrate
2a, 2b Top surface, bottom surface
3 Container
3a Wall part
3b Lid part
4 Accommodation section
4a Opening
4b Side part
4c Bottom part
5 Inflow passage
6 Outflow passage
7 Sheet member
7a Main surface
8 Driving section
9 Base sheet
10 Substrate body
11 Through hole
15 Inflow passage
26 Outflow passage
34 Accommodation section
34d Retaining part
45 Inflow passage
46 Outflow passage
55a, 55b Inflow passage
69, 79 Connecting channel
79d Retaining part
84 Accommodation section
95a, 95b Inflow passage

1. A microchip comprising:
a container encapsulating a fluid;
a substrate including an accommodation section in which the container is placed, the substrate including a top surface and a bottom surface, the accommodation section being opened to the top surface of the substrate; and
a sheet member provided on the top surface of the substrate so as to close the opening of the accommodation section, wherein
the substrate includes:
an inflow passage directly or indirectly connected to the accommodation section, the inflow passage allowing a medium for transporting the fluid to flow into the inflow passage; and
an outflow passage directly or indirectly connected to the accommodation section, the outflow passage allowing the fluid to flow out through the outflow passage.

2. The microchip according to claim 1, further comprising a driving section connected to the inflow passage, the driving section causing the medium to flow into the inflow passage to transport the fluid.

3. The microchip according to claim 2, wherein the medium is a gas, and the driving section causes the gas to flow into the inflow passage.

4. The microchip according to claim 1, wherein the inflow passage and the outflow passage are directly connected to the accommodation section.

5. The microchip according to claim 4, wherein a part of at least one of the inflow passage and the outflow passage is provided on the top surface side of the substrate, and walls of the part on the top surface side are covered with the sheet member.

6. The microchip according to claim 5, wherein a part of the inflow passage and a part of the outflow passage are provided on the top surface side of the substrate, and walls of the inflow passage and the outflow passage on the top surface side are covered with the sheet member.

7. The microchip according to claim 4, wherein the inflow passage and the outflow passage are provided inside the substrate.

8. The microchip according to claim 5, wherein
the outflow passage is provided inside the substrate,
the accommodation section includes a retaining part inside the substrate, the retaining part being connected to the outflow passage, a cross-sectional area of the retaining part in a direction perpendicular to a fluid transporting direction, which is a direction in which the fluid is transported, being larger than a cross-sectional area of the outflow passage in the direction perpendicular to the fluid transporting direction.

9. The microchip according to claim 1, wherein the inflow passage comprises a plurality of inflow passages.

10. The microchip according to claim 1, further comprising a connecting channel connected to the accommodation section, wherein
the inflow passage and the outflow passage are indirectly connected to the accommodation section via the connecting channel.

11. The microchip according to claim 1, wherein the substrate includes a base sheet and a substrate body on the base sheet, the substrate body including a through hole.
